(19) United States
(12) Patent Application Publication
(10) Pub. No.: US 2009/0120174 A1
(43) Pub. Date: May 14, 2009

(54) MISFIRE DETECTING APPARATUS FOR AN INTERNAL COMBUSTION ENGINE

(75) Inventors: Masato Nodera, Kariya-city (JP); Jonathan Saunders, Coventry (GB)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/270,266

(22) Filed: Nov. 13, 2008

(30) Foreign Application Priority Data
Nov. 14, 2007 (JP) 2007-295132

(51) Int. Cl. G01M 15/11

(52) U.S. Cl. 73/114.04

(57) ABSTRACT

An engine speed variation after one power stroke from a misfire has an opposite sign (plus or minus) relative to an engine speed variation at a misfire. A computer determines whether the misfire exists in the subject cylinder based on the engine speed variation between the subject cylinder and the subject cylinder after one power stroke. In order to detect any kinds of misfire, the computer computes a difference value between a current engine speed variation and an engine speed variation before 360° CA or after 360° CA, a difference value between a current engine speed variation and an engine speed variation before 720° CA or after 720° CA, and a difference value between a current engine speed variation and an engine speed variation before 720/(cylinder number)° CA or after 720/(cylinder number)° CA. These three difference values are respectively compared with a misfire determination value to perform a misfire detection.

### CROSS-REFERENCE TO RELATED APPLICATION

This application is based on Japanese Patent Application No. 2007-295132 filed on Nov. 14, 2007, the disclosure of which is incorporated herein by reference.

### FIELD OF THE INVENTION

The present invention relates to a misfire detecting apparatus for an internal combustion engine, which determines whether a misfire exists with respect to each cylinder based on a variation in engine speed.

### BACKGROUND OF THE INVENTION

As shown in JP-6-336948A, which is referred to as Patent Document 1, and JP-10-54295A (U.S. Pat. No. 5,728,941), which is referred to as Patent Document 2, a conventional misfire detecting apparatus detects engine speed (angular speed) every combustion stroke of each cylinder, and computes a engine speed variation (angular speed variation) between a cylinder which is subject for a misfire detection and the cylinder before one combustion stroke. Based on the engine speed variation, the apparatus determines whether a misfire exists in each cylinder.

Specifically, in Patent Document 1, the apparatus computes a difference value between a current engine speed variation in the subject cylinder and an engine speed variation before 360° CA in the cylinder before one power stroke. Then, the apparatus compares the difference value with a misfire determination value to determine whether a misfire exists in each cylinder.

In Patent Document 2, the apparatus computes a difference value between a current engine speed variation in the subject cylinder and an engine speed variation before 360° CA in the cylinder before one power stroke, a difference value between the current engine speed variation and the engine speed variation before 720° CA, and a difference value between the current engine speed variation and the engine speed variation before 720/(cylinder number)° CA. These difference values are respectively compared with the misfire determination value to determine whether a misfire exists in the subject cylinder

In the above misfire detecting apparatus shown in Patent Documents 1 and 2, a misfire in each cylinder is detected by use of an engine speed variation between the subject cylinder and the cylinder before one combustion stroke. As the number of cylinder of the engine increases, the engine speed variation at the time of misfire decreases. Thus, when the difference of engine speed variation between the misfire and the normal combustion becomes small, the conventional apparatus hardly distinguish the misfire from the normal combustion with high accuracy in certain engine driving condition. Especially, during a warming up of the catalyst after cold start, the ignition timing is retarded in order to increase the exhaust gas temperature, so that the combustion becomes slow and the engine speed variation between the misfire and the normal combustion becomes small. Thus, the misfire detection becomes difficult.

### SUMMARY OF THE INVENTION

The present invention is made in view of the above matters, and it is an object of the present invention to provide a misfire detecting apparatus for an internal combustion engine, which is able to detect a misfire in each cylinder more precisely.

According to the present invention, a misfire detecting apparatus for an internal combustion engine having a plurality of cylinder, determines whether a misfire occurs in each cylinder based on an engine speed variation. The misfire detecting apparatus includes an engine speed detecting means for detecting a rotational speed of the engine with respect to every power stroke of each cylinder; an engine speed variation computing means for computing an engine speed variation between a cylinder subject for a misfire detection and a cylinder after one power stroke based on a detection value detected by the engine speed detecting means; and a misfire determination means for determining whether a misfire occurs in the cylinder subject for the misfire detection by use of the engine speed variation.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view of an engine control system according to an embodiment of the present invention;

FIG. 2 is a time chart showing a behavior of an engine speed variation in a case that successive misfires occur in a single cylinder;

FIG. 3 is a chart for explaining a relationship between an engine speed variation at time of misfire, an engine speed variation before one power stroke relative to the misfire, and an engine speed variation after one power stroke relative to the misfire; and

FIGS. 4 to 6 are flowcharts showing processes of a misfire detection routine.

### DETAILED DESCRIPTION OF EMBODIMENTS

An embodiment of the present invention will be described hereinafter. In this embodiment, the present invention is applied to an intake port injection engine.

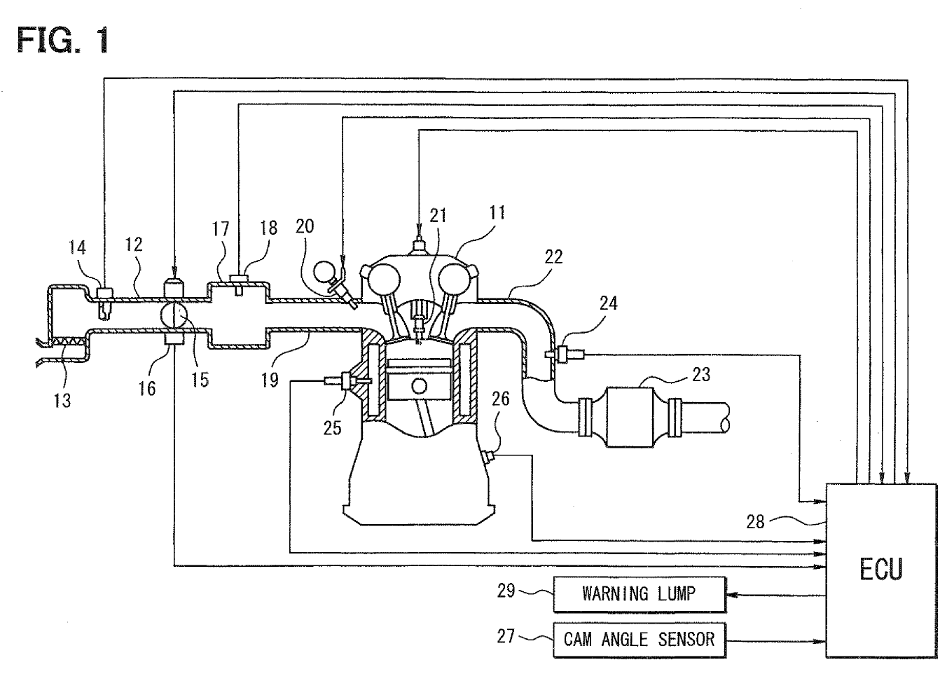

Referring to FIG. 1, an engine control system is explained.

An air cleaner 13 is arranged upstream of an intake pipe 12 of an internal combustion engine 11 which has six cylinders or more. An airflow meter 14 detecting an intake air flow rate is provided downstream of the air cleaner 13. A throttle valve 15 driven by a DC-motor and a throttle position sensor 16 detecting a throttle position are provided downstream of the air flow meter 14.

A surge tank 17 including an intake air pressure sensor 18 is provided down steam of the throttle valve 15. The intake air pressure sensor 18 detects intake air pressure. An intake manifold 19 which introduces air into each cylinder of the engine 11 is provided downstream of the surge tank 17, and the fuel injector 20 which injects the fuel is provided at a vicinity of an intake port of the intake manifold 19 of each cylinder. The present invention can be applied to an internal combustion engine other than the direct injection engine.

A spark plug 21 is mounted on a cylinder head of the engine 11 corresponding to each cylinder. Each spark plug 21 receives high voltage generated by an ignition coil (not shown) to ignite air-fuel mixture in each cylinder.

An exhaust pipe 22 of the engine 11 is provided with a three-way catalyst 23 purifying CO, HC, NOx in the exhaust gas. An exhaust gas sensor 24 such as an air-fuel ratio sensor and an oxygen sensor is disposed upstream of the three-way catalyst 25 in order to detect air-fuel ratio or lean/rich of the exhaust gas. A coolant temperature sensor 25 detecting a coolant temperature, and a crank angle senor 26 (engine speed detecting means) outputting a pulse signal every predetermined crank angle of a crankshaft of the engine 11 are disposed on a cylinder block of the engine 11. The engine speed is detected based on an output interval of the pulse signal of the crank angle sensor 26.

A cam angle sensor 27 is disposed on the cylinder head to output a reference position signal (cylinder discriminate signal) at a reference position in synchronization with a rotation of the camshaft. Based on the reference position signal from the cam angle sensor 27 and a count value of the pulse signal from the crank angle sensor 26, a crank angle is detected to perform a cylinder discrimination.

The outputs from the above sensors are inputted into an electronic control unit 28, which is referred to an ECU hereinafter. The ECU 28 includes a microcomputer which executes an engine control program stored in a ROM (Read Only Memory) to control a fuel injection quantity of the fuel injector 20 and an ignition timing of the spark plug 21 according to an engine running condition,

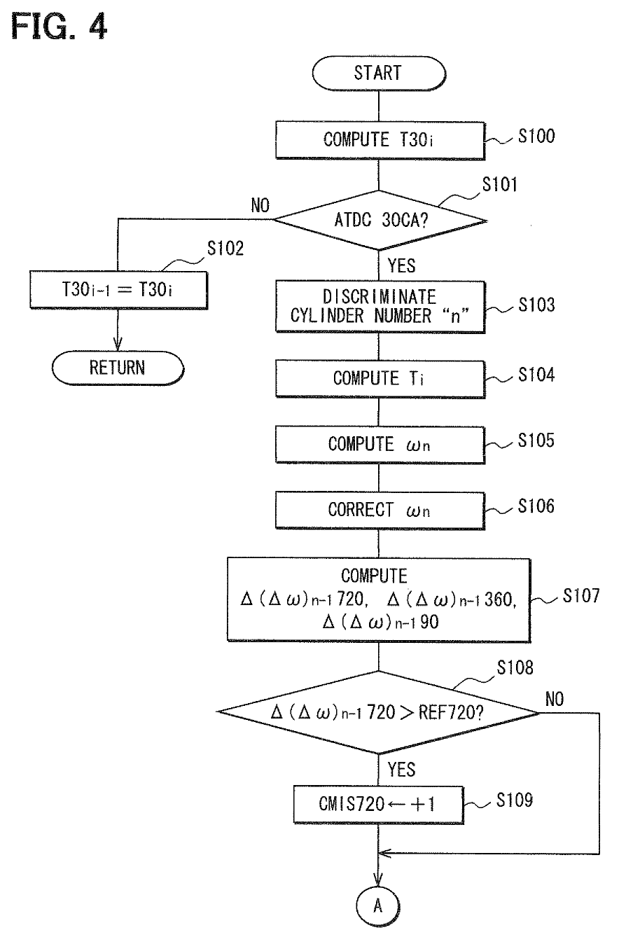

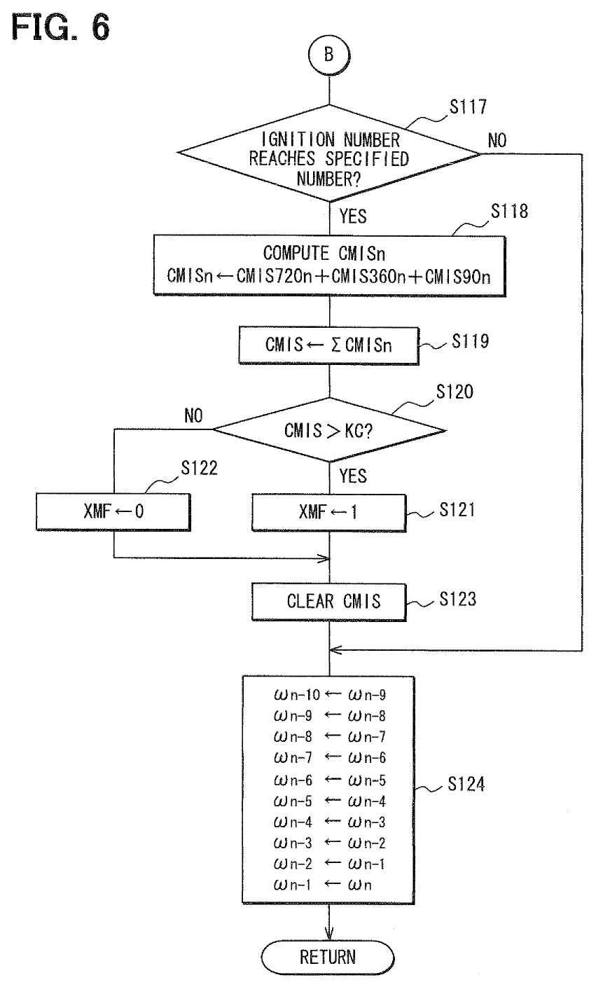

Furthermore, the ECU 28 executes a misfire determination routine shown in FIGS. 4 to 6 while the engine is running. With respect to a cylinder which is a subject for misfire detection, the engine speed is varied after one power stroke of the subject cylinder is performed. In the misfire determination routine, based on the engine speed which is detected every power stroke of each cylinder, the computer computes a variation in engine speed between the subject cylinder and the subject cylinder after one power stroke. Based on the variation in engine speed, the computer determines whether the misfire exists in the cylinder which is subject for misfire detection. When the misfire is detected, a warning lump 29 is turned on, or a display on the instrument panel (not shown) indicates that the misfire exists.

A misfire detecting method will be described hereinafter.

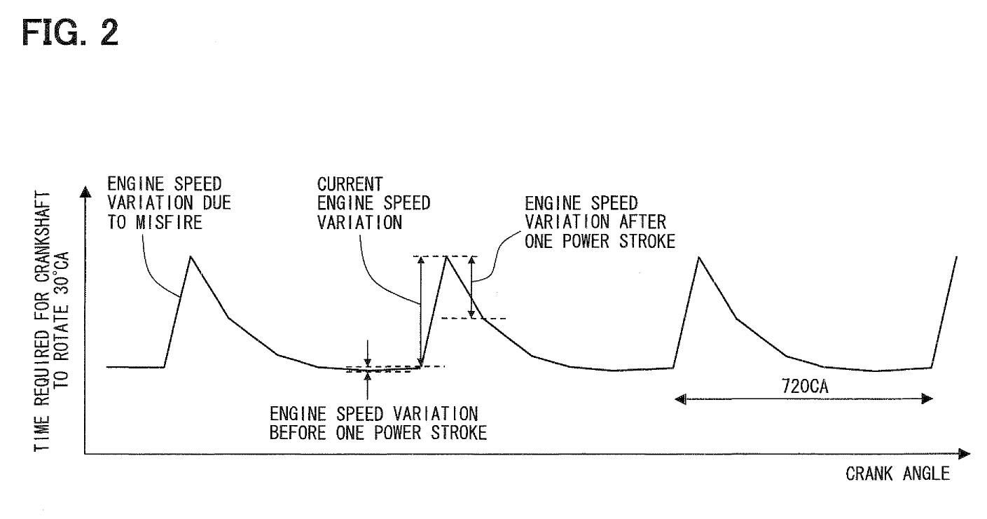

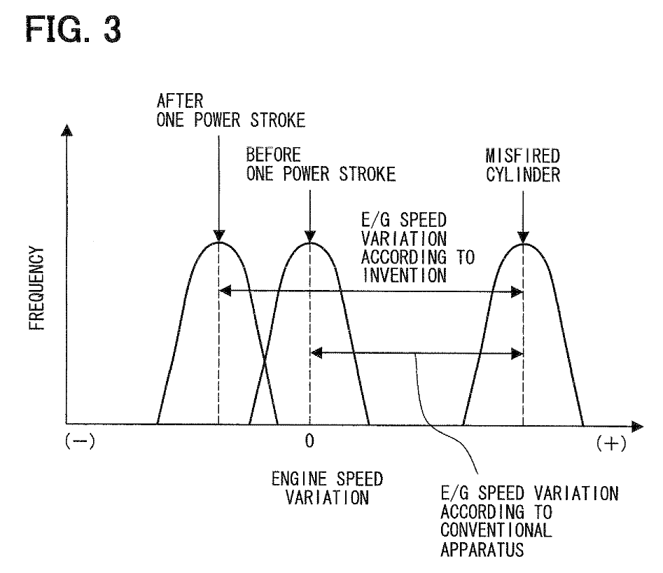

FIG. 2 is a time chart showing a behavior of engine speed variation when the misfire is successively occurred in a single cylinder. Every misfire in the single cylinder decreases the engine speed, whereby the engine speed variation is increased. Before one power stroke from the misfire, a normal combustion condition continues and the engine speed is stable, so that the engine speed variation is substantially zero. After one power stroke from the misfire, the combustion condition becomes normal and the engine speed is rapidly increased. The engine speed variation is also increased. As shown in FIG. 3, the engine speed variation after one power stroke from the misfire has an opposite sign (plus or minus) relative to the engine speed variation at the misfire. In this embodiment, the computer determines whether the misfire exists in the subject cylinder based on the engine speed variation between the subject cylinder and the subject cylinder after one power stroke. According to the above configuration, a difference between the engine speed variation in a case of misfire and the engine speed variation in a case of normal combustion can be enlarged, so that the misfire in each cylinder can be detected more accurately.

Furthermore, in order to detect any kind of misfire occurring in the engine 11, the computer computes a difference α between the currently computed engine speed variation and an engine speed variation computed before 360° CA, a difference β between the currently computed engine speed variation and an engine speed variation computed before 720° CA, and a difference γ between the currently computed engine speed variation and an engine speed variation computed before 720/(cylinder number)° CA. The computer compares three kinds of difference with specified misfire determination values respectively to determine whether the misfire exists in the cylinder which is subject for the misfire detection. Based on the difference β, an intermittent misfire occurring intermittently can be detected. Based on the difference γ, a successive misfire in a counter cylinder of which power stroke advances or retards by 360° CA can be detected. Furthermore, based on the difference ac, successive misfire in a cylinder other than the counter cylinder can be detected. Besides, based on a difference between currently computed engine speed variation and an engine speed variation computed after 360° CA, a difference currently computed engine speed variation and an engine speed variation computed after 720° CA, and a difference currently computed engine speed variation and an engine speed variation computed after 720/(cylinder number)° CA, the same advantage as described above can be obtained.

The misfire detection is performed by the ECU 28 according to a misfire determination routine shown in FIGS. 4 to 6. This misfire detection routine is for an eight-cylinder engine.

The misfire detection routine is performed every 30° CA by an interrupt process based on the pulse signals from the crank angle sensor 26, and corresponds to a misfire determination means. In step S100, the computer computes a time period T30ᵢ required for crankshaft to rotate 30° CA based on a difference between previous interrupt timing and current interrupt timing.

Then, the procedure proceeds to step S101 in which the computer determines whether the current interrupt timing is 30° CA after top dead center. When the answer is NO in step S101, the procedure proceeds to step S102 in which the time period T30ᵢ is set to a previous time period T30ᵢ₋₁. The suffix “i”, “i-1” attached to T30 represents a process number.

When the answer is Yes in step S101, the procedure proceeds to step S103. In step S103, the computer discriminates a current cylinder number “n” based on the reference position signal from the cam angle sensor 27 and the count value of the pulse signal from the crank angle sensor 26. In step S104, the computer computes a time period Tᵢ required for the crankshaft to rotate arbitrary crank angle (integral multiple of 30° CA).

Tᵢ=T30ᵢ+T30ᵢ₋₁+T30ᵢ₋₂+

For example, the time period Tᵢ for the crankshaft to rotate 60° CA is computed as follows:

Tᵢ=T30ᵢ+T30ᵢ₋₁

Then, the procedure proceeds to step S105 in which the above arbitrary crank angle Tᵢ is converted into a crank angular speed ωₙ.

ωₙ=(30×N)/Tᵢ

The crank angular speed ·ωₙ represents the engine speed. The processes in step S100-S105 corresponds to an engine speed detecting means.

Then, the procedure proceeds to step S106 in which the crank angular speed ωₙ is corrected by a learning value of a crank angle deviation (tolerance). After that, the procedure proceeds to step S107 in which an angular speed variation difference value Δ(Δω)ₙ₋₁ with respect to (n-1)th cylinder is computed by use of the crank angular speed ωₙ according to 720° CA difference calculus, 360° CA difference calculus, and 90° CA difference calculus.

The angular speed variation difference value Δ(Δω)ₙ₋₁720, which is computed according to the 720° CA difference calculus, is a difference value between a currently computed angular speed variation {ωₙ₋₂−ωₙ₋₁−(ωₙ₋₁−ωₙ)} and an angular speed variation {ωₙ₋₁₀−ωₙ₋₉−(ωₙ₋₉−ωₙ₋₈)} computed before 720° CA.

Δ(Δω)ₙ₋₁720={ωₙ₋₂−ωₙ₋₁−(ωₙ₋₁−ωₙ)}−{ωₙ₋₁₀−ωₙ₋₉−(ωₙ₋₉−ωₙ₋₈)}

The angular speed variation difference value Δ(Δω)ₙ₋₁360 which is computed according to the 360° CA difference calculus is a difference value between a currently computed angular speed variation {ωₙ₋₂−ωₙ₋₁−(ωₙ₋₁−ωₙ)} and an angular speed variation {ωₙ₋₆−ωₙ₋₅−(ωₙ₋₅−ωₙ₋₄)} computed before 360° CA.

Δ(Δω)ₙ₋₁360={ωₙ₋₂−ωₙ₋₁−(ωₙ₋₁−ωₙ)}−{ωₙ₋₆−ωₙ₋₅−(ωₙ₋₅−ωₙ₋₄)}

The angular speed variation difference value Δ(Δω)ₙ₋₁90 which is computed according to the 90° CA difference calculus is a difference value between a currently computed angular speed variation {ωₙ₋₂−ωₙ₋₁−(ωₙ₋₁−ωₙ)} and an angular speed variation {ωₙ₋₃−ωₙ₋₂−(ωₙ₋₂−ωₙ₋₁)} computed before 90° CA.

Δ(Δω)ₙ₋₁90={ωₙ₋₂−ωₙ₋₁−(ωₙ₋₁−ωₙ)}−{ωₙ₋₃−ωₙ₋₂−(ωₙ₋₂−ωₙ₋₁)}

Besides, 90° CA=720/(cylinder number)° CA=720/8° CA. In a case that the engine 11 is a six-cylinder engine, an angular speed variation difference value Δ(Δω)ₙ₋₁120 is computed according to the 120° CA difference calculus. In a case that the engine 11 is a twelve-cylinder engine, an angular speed variation difference value Δ(Δω)ₙ₋₁60 is computed according to the 60° CA difference calculus.

The angular speed variation which is used in each difference calculus is a variation in crank angular speed ωₙ between the current subject cylinder and the subject cylinder after one power stroke.

With respect to the values Δ(Δω)ₙ₋₁720 and Δ(Δω)ₙ₋₁360, the crank angular speed ωₙ computed in step S105 is used. With respect to the value Δ(Δω)ₙ₋₁90, the crank angular speed ωₙ corrected in step S106 is used. The process in step S107 corresponds to an engine speed variation computing means.

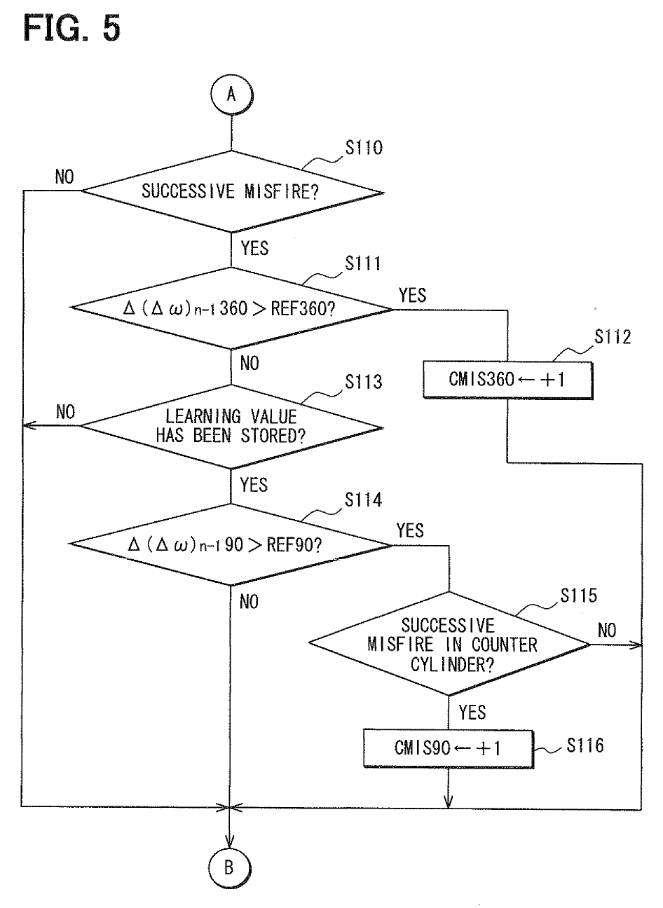

Then, the procedure proceeds to step S108 in which the computer determines the value Δ(Δω)ₙ₋₁720 is greater than a specified misfire determination value REF720. When the answer is Yes in step S108, the computer determines that the intermittent misfire occurs, and the procedure proceeds to step S109. In step S109, a CMIS counter (CMIS 720) corresponding to the cylinder number of a temporary misfire counter is incremented by “1”. Then, the procedure proceeds to step S100 of FIG. 5.

When the answer is No in step S108, the computer determines that no intermittent misfire occurs and the procedure proceeds to step S110.

Although the intermittent misfire can be detected by use of the value Δ(Δω)ₙ₋₁720, the successive misfire occurring in the same cylinder can not be detected by the 720° CA difference calculus. That is, the cylinder in the power stroke before 720° CA is the cylinder currently in the power stroke. Thus, the difference value is computed between the same cylinders according to the 720° CA difference calculus, so that the engine speed variation due to a misfire is cancelled. As the result, the value Δ(Δω)ₙ₋₁720 never exceeds the misfire determination value REF720, so that the successive misfire can not be detected. The way of detecting the successive misfire will be described hereinafter.

In step S110, the computer determines whether there is a possibility that the successive misfire occurs by use of the value Δ(Δω)ₙ₋₁720 and the value REF720. As described above, when the successive misfire occurs, the value Δ(Δω)ₙ₋₁720 hardly varies. Only when the intermittent misfire occurs, the value Δ(Δω)ₙ₋₁720 varies. Hence, the computer determines whether the possibility of the successive misfire exists according to whether no misfire is detected during a specified cycle based on the value Δ(Δω)ₙ₋₁720.

When the answer is No in step S110, the procedure proceeds to step S117.

When the answer is Yes in step S110, the procedure proceeds to step S111 in which the computer determines whether the value Δ(Δω)ₙ₋₁360 is greater than a misfire determination value REF360. When the answer is Yes in step S110, the procedure proceeds to step S112 in which a CMIS counter (CMIS360) corresponding to the cylinder number of a temporary misfire counter is incremented by “1”. Then, the procedure proceeds to step S117.

In this case, since the value Δ(Δω)ₙ₋₁360 is a difference value of angular speed variation between counter cylinders, the successive misfire in the counter cylinder can not be detected. The other successive misfires can be detected. When the answer is No in step S111, the procedure proceeds to step S113 in which the computer determines whether the learning value of the crank angle deviation corresponding to the engine driving condition (engine speed NE, engine load PM) has been stored in the memory. When the answer is No in step S113, the procedure proceeds to step S117 without performing the misfire detection process (steps S114-S116) by use of the value Δ(Δω)ₙ₋₁90. This is because the value Δ(Δω)ₙ₋₁90 is computed by use of the crank angular speed ωₙ corrected by the learning value of the crank angular deviation in step S106.

When the answer is Yes in step S113, the procedure proceeds to step S114. In step S114, the computer determines whether the value Δ(Δω)ₙ₋₁90 is greater than the misfire determination value REF90. When the answer is Yes, the computer determines there is a possibility that a misfire exists. Since the value Δ(Δω)ₙ₋₁90 is the difference value between adjacent cylinders in which the power stroke is deviates by 90° CA from each other, a successive misfire in the adjacent cylinder can not be detected, but a successive misfire in counter cylinder can be detected.

When the answer is Yes in step S114, the procedure proceeds to step S115 in which the computer determines whether a successive misfire occurs in the counter cylinder. When the answer is Yes in step S115, the procedure proceeds to step S116 in which the CMIS counter (CMIS90) corresponding to the cylinder number of the temporary misfire counter is incremented by “1”. Then, the procedure proceeds to step S117. That is, in steps S114 and S115, the successive misfire only in the counter cylinder can be detected. When it is determined that no successive misfire occurs in the counter cylinder in step S115, the procedure proceeds to step S117.

In step S117, the computer determines whether an ignition number which is counted by an ignition number counter (not shown) reaches a specified ignition number (for example, 500). When the answer is No, the procedure proceeds to step S124, and when the answer is Yes, the procedure proceeds to step S118. In step s118, the count values CMID720, CMIS360, CMIS90 counted in steps S109, S112, and S116 are integrated with respect to each cylinder so that the count value CMISn (n=1−8) of the temporary misfire counter is integrated with respect to each cylinder.

CMISn=CMIS720n+CMIS360n+CMIS90n

With respect to data in which the number of misfire is a few, it must be detection error. Such a data can be neglected.

Then, the procedure proceeds to step S119 in which the count value CMISn (n=1−8) of the temporary misfire counter is integrated so that a count value of the counter CMIS representing the number of misfire in all cylinders are computed.

CMIS=ΣCMISn

In step S120, the computer determines whether the count value of the counter CMIS is greater than a specified determination value KC (for example, 100). When the answer is Yes, the procedure proceeds to step S121 in which a misfire flag XMF is set to “1”. When the answer is NO, the procedure proceeds to step S122 in which the misfire flag XMF is reset to “0”. When the misfire flag XMF is set to “1”, it is determined that the emission may be deteriorated and the catalyst 23 may have damages to turn on the warning lump 29.

After steps S121 and S122, the procedure proceeds to step S123 in which all counter such as the counter CMIS, and the counters CMIS720, CMIS360, CMIS90 are cleared. Then the procedure proceeds to step S124 in which the stored data of crank angular speed ton are updated to previous data as follows:

ωₙ₋₁₀←ωₙ₋₉

ωₙ₋₉←ωₙ₋₈

ωₙ₋₈←ωₙ₋₇

ωₙ₋₇←ωₙ₋₆

ωₙ₋₆←ωₙ₋₅

ωₙ₋₅←ωₙ₋₄

ωₙ₋₄←ωₙ₋₃

ωₙ₋₃←ωₙ₋₂

ωₙ₋₂←ωₙ₋₁

ωₙ₋₁←ωₙ₋ₙ

According to the present embodiment, the computer determines whether a misfire exists in a cylinder which is subject to the misfire detection based on an engine speed variation (angular speed variation) between the subject cylinder and the subject cylinder after one power stroke. Hence, as shown in FIG. 3, the difference between the engine speed variation in a case of misfire and the engine speed variation in a case of normal combustion can be enlarged, so that the misfire in each cylinder can be detected more accurately.

Furthermore, according to the present embodiment, since each of values Δ(Δω)ₙ₋₁360, Δ(Δω)ₙ₋₁720, and Δ(Δω)ₙ₋₁90 is respectively compared with the misfire determination value to detect the misfire in the subject cylinder, all kinds of misfire such as the intermittent misfire, the successive misfire in a single cylinder and the successive misfire in the counter cylinder can be detected.

According to the present invention, one or two of the different value Δ(Δω)ₙ₋₁360, Δ(Δω)ₙ₋₁720, and Δ(Δω)ₙ₋₁90 may be computed to detect the misfire.

According to the present embodiment, even if the engine is under a retard control, the misfire in each cylinder can be detected accurately.

The misfire detection routine shown in FIGS. 4 to 6 is for the eight-cylinder engine. The present invention can be applied to a six-cylinder engine, a ten-cylinder engine, a twelve-cylinder engine, a five or less cylinder engine. Especially when the present invention is applied to a six or more cylinder engine, the large advantage can be obtained.

The present invention is not limited to an intake port injection engine. The present invention can be applied to a direct injection engine or a dual injection engine.

What is claimed is:

1. A misfire detecting apparatus for an internal combustion engine having a plurality of cylinder which determines whether a misfire occurs in each cylinder based on an engine speed variation, the misfire detecting apparatus comprising:
an engine speed detecting means for detecting a rotational speed of the engine with respect to every power stroke of each cylinder;
an engine speed variation computing means for computing an engine speed variation between a cylinder which is subject for a misfire detection and a cylinder after one power stroke based on a detection value detected by the engine speed detecting means; and
a misfire determination means for determining whether a misfire occurs in the cylinder which is subject for the misfire detection by use of the engine speed variation.

2. A misfire detecting apparatus according to claim 1, wherein
the misfire determination means computes
a difference value between a currently computed engine speed variation and an engine speed variation before 360° CA or after 360° CA,
a difference value between a currently computed engine speed variation and an engine speed variation before 720° CA or after 720° CA, and
a difference value between a currently computed engine speed variation and an engine speed variation before 720/(cylinder number)° CA or after 720/(cylinder number)° CA, and
the misfire determination means respectively compares three difference values with a specified misfire determination value to determine whether a misfire occurs in the cylinder which is subject to the misfire detection.

3. A misfire detecting apparatus according to claim 1I, wherein
the misfire determination means determines whether a misfire occurs in the cylinder which is subject for the misfire detection by use of the engine speed variation between the cylinder which is subject for the misfire detection and a cylinder after one power stroke at least during an ignition timing retard control.

4. A misfire detecting apparatus according to claim 15 wherein
the internal combustion engine is a six-cylinder or more cylinder engine

5. A misfire detecting apparatus according to claim 1, wherein
the engine speed variation computing means computes a first engine speed variation between the cylinder which is subject for the misfire detection and the cylinder after one power stroke, and a second engine speed variation between the cylinder which is subject for the misfire detection and the cylinder before one power stroke,
a misfire determination means for determining whether a misfire occurs in the cylinder which is subject for the misfire detection based on the first engine speed variation and the second engine speed variation.
